(19) United States
(12) Patent Application Publication
(10) Pub. No.: US 2018/0232454 A1
(43) Pub. Date: Aug. 16, 2018

(54) PAGE VIEW NAVIGATION SYSTEM AND INFORMATION NETWORK

(71) Applicant: Mark Daniel Grace, Ottawa (CA)

(72) Inventor: Mark Daniel Grace, Ottawa (CA)

(21) Appl. No.: 15/893,282

(22) Filed: Feb. 9, 2018

Related U.S. Application Data
(60) Provisional application No. 62/457,159, filed on Feb. 9, 2017.

(30) Foreign Application Priority Data
Mar. 30, 2017 (CA) 2962790

(51) Int. Cl. G06F 17/30; G06F 17/22; G06F 3/0483

(52) U.S. Cl. CPC G06F 17/30873; G06F 17/30905; G06F 3/0483; G06F 17/3089; G06F 17/2235; G06F 17/30867

(57) ABSTRACT

An internet information network is provided by linking content from a plurality of in-webpage views on a plurality of webpages using one or more page view (PV) navigator(s). Each PV navigator comprises a PV-anchor marking an in-webpage view on a webpage and one or more PV-links accessible (directly or indirectly) from said webpage. Each PV-link when activated navigates a user to a distinct PV-anchor on a distinct webpage. The application of a plurality of PV navigators (PV navigation system) to link the content (of in-webpage views) arranged according to a user-defined standard allows the user to browse for similar information efficiently across the information network while maintaining a focused orientation with respect to content of interest. The integration of a PV-database of PV-link records into a PV-navigator and PV-search means allows for the construction of scalable, custom and dynamic in-webpage view information networks according to the present disclosure.

### FIELD OF THE INVENTION

The present invention relates to the field of internet information networks and internet navigation systems.

### BACKGROUND OF THE INVENTION

Websites on the internet are currently organized and navigated for the most part using vertical (drill down) menu systems. This hierarchical approach to organizing information and navigating the internet means that websites act as isolated information islands.

Users hop laterally from one website to the next (e.g. using links) where the vertical menu navigation systems are presented. Followed links take the user to the top of home pages, and the top of webpages located deeper in a website's hierarchical structure. In a variation of a vertical navigation system, same page links are used to navigate up and down a single page.

The use of vertical navigation tools and simple linking to different pages limits the efficiency of information navigation on the internet. After navigating to a webpage, the user often needs to reorient themselves so as to understand their present location within the hierarchical structure of the website. Each time a user links to a new page, the user must either scroll or navigate down to information of interest, or else drill vertically down into the website using menus to other webpages. Alternatively, if the user is navigated to an in-webpage view the user must again take the time to orient themselves, and understand the surrounding content context within which the information they have been directed to is set out.

There remains a need to facilitate more efficient access to and understanding of internet information of interest to a user, as well as more efficient webpage navigation among webpages and websites.

### SUMMARY OF THE INVENTION

It is an object of the present invention to provide for more efficient webpage navigation and better organized and efficiently scalable internet information networks. An in-webpage view navigator tool and system according to the present disclosure provide the means for creating more efficiently navigable and scalable information networks, and may be leveraged as part of a user-defined standard for content presentation, organization and information processing across linked webpages.

In one aspect, there is provided a page view navigator for navigating in-webpage views on a plurality of webpages, comprising a page view anchor marking an in-webpage view on a webpage and one or more page view links accessible from said webpage, each link being operatively associated with a distinct webpage and configured to recognize a distinct page view anchor on said distinct webpage.

In another aspect, there is provided a page view navigation system for an internet information network comprising a plurality of page view navigators for navigating a plurality of in-webpage views on a plurality of webpages, wherein each page view navigator comprises a page view anchor marking an in-webpage view on a webpage and one or more page view links accessible from said webpage, each link being operatively associated with a distinct webpage and configured to recognize a distinct page view anchor on said distinct webpage.

In a further aspect, there is provided a method of navigating an internet information network comprising the step of using a page view navigation system, said page view navigation system comprising a plurality of page view navigators for navigating a plurality of in-webpage views on a plurality of webpages, wherein each page view navigator comprises a page view anchor marking an in-webpage view on a webpage and one or more page view links accessible from said webpage, each link being operatively associated with a distinct webpage and configured to recognize a distinct page view anchor on said distinct webpage.

In still a further aspect, there is a provided a process for constructing an internet information network comprising the step of linking in-webpage views of a plurality of webpages using one or more page view navigators, wherein each page view navigator comprises a page view anchor marking an in-webpage view on a webpage and one or more page view links accessible from said webpage, each link being operatively associated with a distinct webpage and configured to recognize a distinct page view anchor on said distinct webpage.

In yet another aspect, there is provided an internet information network comprising a plurality of in-webpage views linked by a one or more page view navigators, wherein each page view navigator comprises a page view anchor marking an in-webpage view on a webpage and one or more page view links accessible from said webpage, each link being operatively associated with a distinct webpage and configured to recognize a distinct page view anchor on said distinct webpage.

In various embodiments, the page view navigator further comprises one or more page view search terms on the same webpage as the page view anchor and a page view database operatively associated with said page view search terms, wherein activating the one more page view search terms initiates a page view database search in the page view database to access the one or more page view links.

In further embodiments, the one or more page view links are presented to the user in a page view navigator panel.

In still further embodiments, said page view navigator panel is part of the in-webpage view marked by the page view anchor.

In other embodiments, the in-webpage views on the plurality of webpages comprise content configured according to a user-defined standard.

In still other embodiments, the user-defined standard is a set of content management rules for organizing, processing, and displaying information.

### BRIEF DESCRIPTION OF THE DRAWINGS

These and other features of the invention will become more apparent in the following detailed description in which reference is made to the appended drawings.

FIG. 1: Schematic representation of an exemplary page view navigator (PV-navigator) system and resulting information network according to the present disclosure.

FIG. 2: Table 1 represents the vertical and horizontal (lateral) navigation of webpages in the information network based on the PV-navigator in FIG. 1.

FIG. 3: A first webpage (shown with a top page view) in an information network according to the present disclosure.

FIG. 4: PV-anchor view and PV-navigator of the first webpage in FIG. 3.

FIG. 5: A second webpage (shown with a top page view) in an information network, according to the present disclosure.

FIG. 6: PV-anchor view and PV-navigator of the second webpage in FIG. 5.

FIG. 7: A third webpage (shown with a top page view) in an information network, according to the present disclosure.

FIG. 8: PV-anchor view and PV-navigator of the third webpage in FIG. 7.

FIG. 9: Schematic representation of a second exemplary PV-navigator system and resulting information network according to the present disclosure.

FIG. 10: Schematic representation of a third exemplary PV-navigator system and resulting information network according to the present disclosure.

FIG. 11: Schematic representation of a fourth exemplary PV-navigator system and resulting information network according to the present disclosure.

### DETAILED DESCRIPTION OF THE INVENTION

The present invention relates to the field of internet information networks and internet navigation systems, and more particularly to a PV-navigator, systems, methods and processes.

Various features of the invention will become apparent from the following detailed description taken together with the illustrations in the Figures. The design factors, construction and use of the PV navigator and system to create novel information networks as disclosed herein are described with reference to various examples representing embodiments which are not intended to limit the scope of the invention as described and claimed herein. The skilled technician in the field to which the invention pertains will appreciate that there may be other variations, examples and embodiments of the invention not disclosed herein that may be practiced according to the teachings of the present disclosure without departing from the scope and spirit of the invention.

### Definitions

Unless defined otherwise, all technical and scientific terms used herein have the same meaning as commonly understood by one of ordinary skill in the art to which this invention belongs.

The use of the word “a” or “an” when used herein in conjunction with the term “comprising” may mean “one,” but it is also consistent with the meaning of “one or more,” “at least one” and “one or more than one.”

As used herein, the terms “comprising,” “having,” “including” and “containing,” and grammatical variations thereof, are inclusive or open-ended and do not exclude additional, un-recited elements and/or method steps. The term “consisting essentially of” when used herein in connection with a composition, use or method, denotes that additional elements and/or method steps may be present, but that these additions do not materially affect the manner in which the recited composition, method or use functions. The term “consisting of” when used herein in connection with a composition, use or method, excludes the presence of additional elements and/or method steps. A composition, use or method described herein as comprising certain elements and/or steps may also, in certain embodiments consist essentially of those elements and/or steps, and in other embodiments consist of those elements and/or steps, whether or not these embodiments are specifically referred to.

As used herein, the term “about” refers to an approximately +/−10% variation from a given value. It is to be understood that such a variation is always included in any given value provided herein, whether or not it is specifically referred to.

The use of any and examples or exemplary language, e.g. “such as”, “exemplary embodiment”, and “for example” is intended to illustrate or denote aspects, embodiments, variations, elements or features of the invention and not intended to limit the scope of the invention.

As used herein, the term “information network” refers to content on a plurality of webpages that is linked using one or more page view (PV) navigators. Accordingly, an information network may also refer to a collection of webpages linked using one or more PV-navigators, or a plurality of linked in-webpage views in a plurality of webpages. The content of an information network according to the present disclosure may be presented according to user-defined formats, layouts, interfaces or other standards and may include features of PV-navigators, such as PV-anchors, PV-links, PV-search terms and PV-navigator panels.

As used herein, the terms “in-webpage view” or “page view (PV)” refer to a displayed webpage view, which begins at a point below the top of a webpage. An in-webpage view is associated (marked) with an (encoded) anchor point.

As used herein, the term “PV-anchor” refers to a (hidden or unhidden) marker that designates and defines the starting point of an in-webpage view.

As used herein, the term “PV-database” refers to a database that contains PV-link information or can generate PV-links, has one or more PV-link fields, and has one or more PV-searchable fields.

As used herein, the term “PV-link” refers to an encoded combination of a webpage URL (navigation address) and PV-anchor (in-webpage view marker). Navigation to the webpage and associated in-webpage view occurs when a PV-link is activated.

As used herein, the term “PV-link field” refers to one or more database fields defined and designated for PV-link information within a PV-database.

As used herein, the term “PV-navigator” refers to a combination of computer implemented features configured to facilitate in-webpage view to in-webpage view content navigation (which content may be presented or structured according to a user-defined standard) to form an information network comprising or otherwise residing within plurality of webpages. A PV-navigator may comprise feature such as a PV-anchor, one or more PV-links, which may be optionally presented to a user in a PV-navigator-panel. A PV-navigator can also be configured such that one or more PV-links are contained within a database record(s) of a PV-database.

As used herein, “PV-navigator panel” refers to a user interface panel located on a webpage for activating PV-links and/or PV-search terms.

As used herein, the term “PV-search” refers to the query process applied to a PV-database to generate search results which provide access to PV-links, may generate PV-links and may also result in the activation of a PV-link. The search process may be performed on a PV-search-field index structure (optimized search) or using a sequential search on the data within the PV-search field using PV-search-term(s) linked to a PV-search-field(s).

As used herein, the term “PV-searchable field” refers to a field within a PV-database that has been defined as searchable. A PV-searchable field is linked to one or more PV-search terms.

As used herein, the term “PV-search term” refers to the search criteria to be applied in a PV-search. PV-search terms which may be optionally presented (with or without PV-links) in a PV-navigator panel are the means for accessing the PV-links from a PV-database. The PV-search term can be comprised of text (unique, formatted, static, etc.), images, html forms (ex. radio buttons, selection boxes, text boxes, etc.) code (java, javascript, python, etc.) etc. Activating a PV-search-term initiates a PV-search.

As used herein, the term “search results” refers to the matching PV-database records of PV-links displayed in a user-defined webpage after processing a PV-search, or activated to directly navigate to an in-webpage view.

As used herein, the term “user-defined” refers to the selection, design, and application of strategies or criteria for presenting and providing access to content in an information network. A “user-defined standard” refers to the display, organization and processing of content (information) in a standardized way across a plurality of webpages.

It is contemplated that any embodiment discussed herein can be implemented with respect to any disclosed method, use, device or system, and vice versa. Furthermore, devices and systems of the invention can be used to achieve the disclosed methods and uses.

### Page View Navigation System

The in-webpage view navigation system of the present disclosure provides for the creation of novel and more efficiently navigable information networks.

The PV-navigation system of the present disclosure comprises one or more in-webpage PV-anchors and one or more PV-links that provide webpage link information. Linked in-webpage views are navigated by activating the PV-links. By applying user defined standards and customized PV-links which recognize distinct PV anchors on distinct webpages navigation can occur vertically, laterally, vertically and laterally, between webpages to standard (user defined) and non-standard views. Webpage navigation can be further expanded on when PV-databases are used in conjunction with PV-search-terms. When a PV-navigation system is applied to in-webpage views of content presented according to a user-defined standard, the user is able to browse for similar information efficiently across an information network while maintaining a focused orientation with respect to content of interest.

### PV-Navigator

A PV-navigator according to the present disclosure is the means for linking in-webpage views to form an information network according to the present disclosure and comprises a combination of computer implemented features configured to facilitate in-webpage view to in-webpage view content navigation. A PV-navigator may comprise features such as a PV-anchor, and one or more PV-links, which may be optionally presented to a user in a PV-navigator-panel. A PV-navigator can also be configured such that one or more PV-links are contained within a database record(s) of a PV-database and accessed using a PV-search protocol.

### PV-Anchor

A webpage in an information network of the present disclosure may comprise one or more PV-anchors. Each PV-anchor represents or marks an in-webpage view (of content). PV-anchors within an information network according to the present disclosure are the nodal points for facilitating an efficient, multi-directional browsing experience for users to track like information or content across a plurality of webpages, for example, when structured or presented according to a user-defined standard. Navigation to these in-webpage PV-anchors occurs once a PV-link is activated. In-webpage PV-anchors can be coded in HTML, XML, java, JavaScript, python, and other computer coding languages that support coding of PV-anchor(s) within a webpage.

In one embodiment, a single PV-anchor is coded on each linked webpage of an information network for designating in-webpage views. The PV-anchor can be located anywhere below the top of the webpage.

In another embodiment, multiple PV-anchors are coded on each linked webpage for designating in-webpage views of an information network. The PV-anchors can be located anywhere below the top of the webpage.

In another embodiment, one or more PV-anchors is coded on each linked webpage of an information network for designating standardized in-webpage views. The PV-anchor in this embodiment is set at a standard location (user-defined) and thereby marks a standard view which is displayed to the user upon activating PV-links operatively-associated with said standardized PV-anchors when navigating to webpages using the PV-navigation system.

### PV-Links

PV-link(s) may or may not be arranged and presented to a user within a PV-navigator panel. A PV-link contains a combination of a webpage URL (navigation address) and PV-anchor (in-webpage view). Navigation to a webpage and associated in-webpage view within an information network occurs when a PV-link is activated. PV-links can also be accessed from a PV-database using PV-search-terms. This access (and activation in some embodiments) of PV-links can be a direct output from a PV-search or made available from a search results webpage. The layout of PV-links on a webpage of an information network or in search results webpage may be standardized and/or customized according to user preferences. A PV-navigator or PV-navigator panel may comprise active and inactive PV-links. Inactive PV-link(s) in a PV-navigator may be distinguished using unique color, text, image, greyed out buttons, sound, or other indicators.

In one embodiment, the PV-link(s) are displayed as text within a PV-navigator panel. Navigation occurs once a PV-link (text) is activated.

In another embodiment, the PV-link(s) are displayed as images within a PV-navigator panel. Navigation occurs once a PV-link (image) is activated.

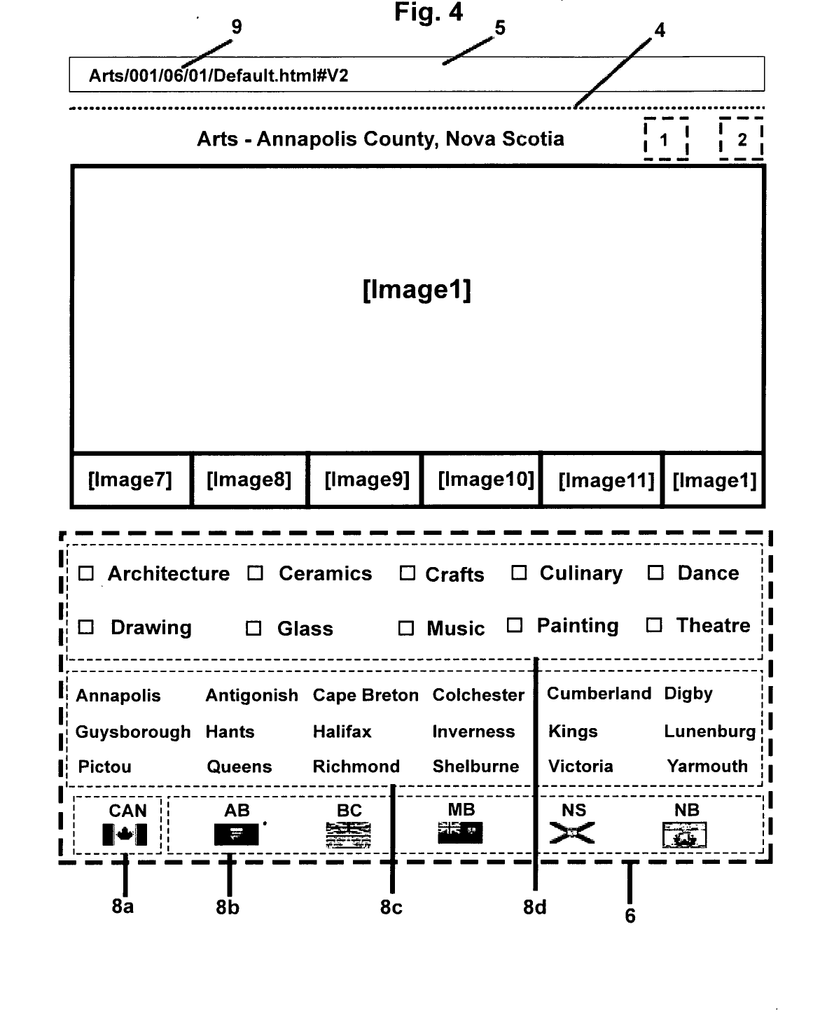

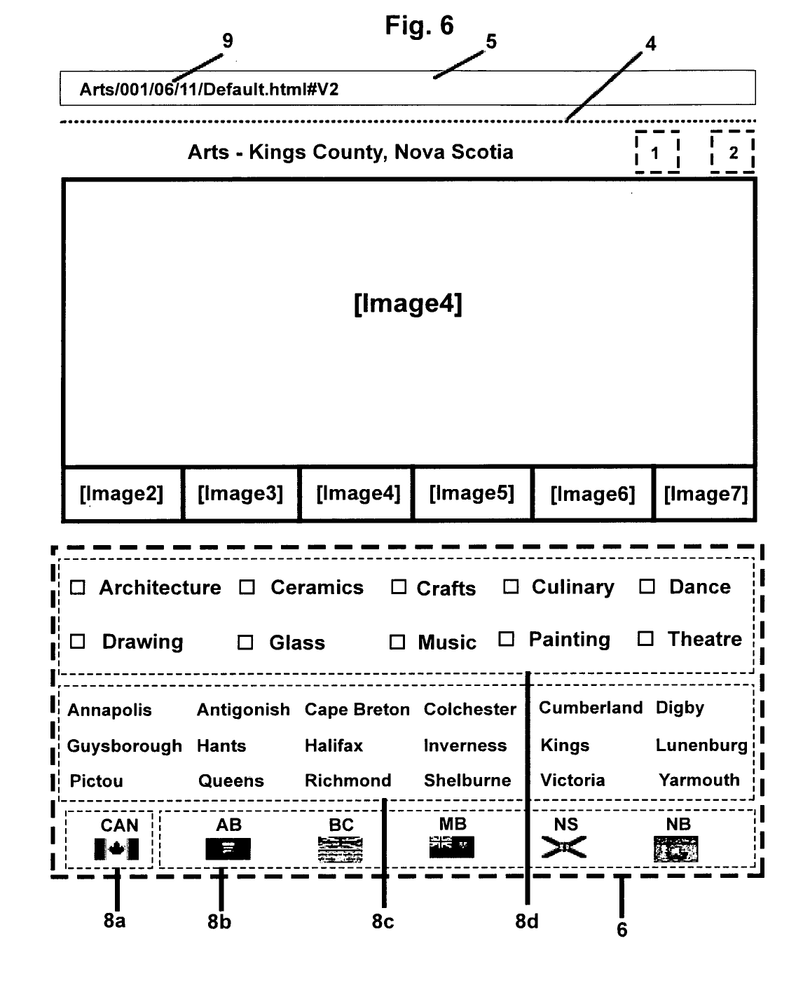

In another embodiment, the PV-link(s) are displayed in a form (e.g. using radio buttons; see feature 8d in FIGS. 4, 6, and 8). Navigation starts once the PV-link (radio button) is activated. Forms can include drop down boxes, selection boxes, lists, or other form variations that may be designed by one skilled in the art.

In another embodiment, the PV-link(s) are displayed using coding languages such as java. Navigation occurs once the PV-link is activated. HTML, XML, JavaScript, python, and other computer coding languages that support coding of URL and anchor information can be used to create a PV-link.

In another embodiment, the PV-link(s) are displayed as a combination of text, image, form, code, and/or other display variations). Navigation occurs once the PV-link is activated.

In another embodiment, the PV-link(s) are encoded in the matching records of a PV-database search results webpage. Navigation occurs when a matching record(s) is selected thereby activating the PV-link(s).

### PV-Navigator Panel

The PV-navigator panel functions as a user interface and is comprised of one or more PV-links and/or one or more PV-search-terms. The PV-navigator panel may also contain control elements such as an (optional) search button to activate a PV-search, Boolean operator buttons to combine PV-search-terms, etc. PV-navigator panels can be displayed and distinguished using standardized and/or customized features of color, images, text, patterns, sounds and other feature variations. PV-navigator panels can be coded in HTML, XML, java, JavaScript, python, and other computer coding languages that support coding of PV-links and PV-search-terms within a webpage.

(In one embodiment, standard (user defined) PV-links or a standard PV-navigator panel is used to provide navigation to and between in-webpage views of the linked webpages of an information network.

In another embodiment, a combination of standard (user defined) PV-links or PV-navigator panels and customized PV-links or PV-navigator panels (e.g. with additional PV-links added to the panel) are used on webpages to provide navigation to user-defined in-webpage views in linked webpages of an information network.

In another embodiment, standardize and/or customized PV-links or PV-navigator panels that have standardized PV-links removed are used on webpages to provide navigation to in-webpage views in linked webpages of an information network. These PV-navigator panels provide partial, but not offer end-to-end navigation between all linked webpages and/or all PV-anchor views of an information network according to the present disclosure.

### PV-Database

The integration of a PV-database into a PV-navigation system is a means to efficiently scale, dynamically customize or select segments of an information network to browse according to the present disclosure.

In one embodiment, PV-links of a PV-navigator are accessed by way of conducting a PV-search in a PV-database. PV-search terms are used to initiate a PV-database query process (PV-search) in order to access PV-links, by leveraging one or more PV-link fields and one or more PV-searchable fields.

### Search Results (Webpage)

In one embodiment, the search results of a PV-search generate a plurality of PV-links displayed in a search results webpage. The PV-links on a search results webpage may be presented as a series of links, in a panel format, or according to another a user-defined standard.

In another embodiment, the search results webpage displays one or more matching records from one or more PV-searches. In another embodiment, the search results webpage displays one or more matching records from one or more PV-databases.

The display format of the search results is user defined. Each matching record in the search results webpage contains the PV-link (encoded) navigation information. Selecting a matched record from the webpage activates the PV-link. Selecting more than one matching record from the search results webpage opens a new tab in the internet browser for each selection.

In another embodiment, a PV-search in a PV-database and resulting search results webpage is used to generate information networks according to the present disclosure in real-time. The search output displayed in a search results webpage can then be coupled with further processing means and protocols for build new information networks in real-time by generating dynamic webpages from matching records. Each dynamic webpage would contain a PV-anchor and one or more PV-links. A standardized PV-navigator panel can be also be generated to a provide a user-defined standard linking mechanism for the new, dynamically generated information network.

### Information Network

The information networks according to the present disclosure are comprised of a plurality of webpages, or in-webpage content/information segments in a plurality of webpages that contain and are linked using one or more PV-navigators.

In one embodiment, the information network is comprised of webpages or content/information segments that have been catalogued, organized and displayed using a rule based information management methodology (user defined). The webpages are linked using one or more PV-navigators.

In another embodiment, the information network is comprised of webpages or content/information segments that have been organized regionally by location. The webpages are linked using one or more PV-navigators.

In still another embodiment, the information network is comprised of webpages or content/information segments that have been organized by date. The webpages are linked using one or more PV-navigators.

In s further embodiment, the information network is comprised of webpages or content/information segments that have been organized by subject. The webpages are linked using one or more PV-navigators.

In still a further embodiment, the information network is comprised of webpages or content/information segments that have been organized by language. The webpages are linked using one or more PV-navigators.

To gain a better understanding of the invention described herein, the following examples are set forth to illustrate the design, construction and use of the page view navigation systems and information networks of the present disclosure. It will be understood that these examples are intended to describe illustrative embodiments of the invention and are not intended to limit the scope of the invention in any way

### EXAMPLES

### Example 1: Standardized Page View Navigation System and Information Network Design

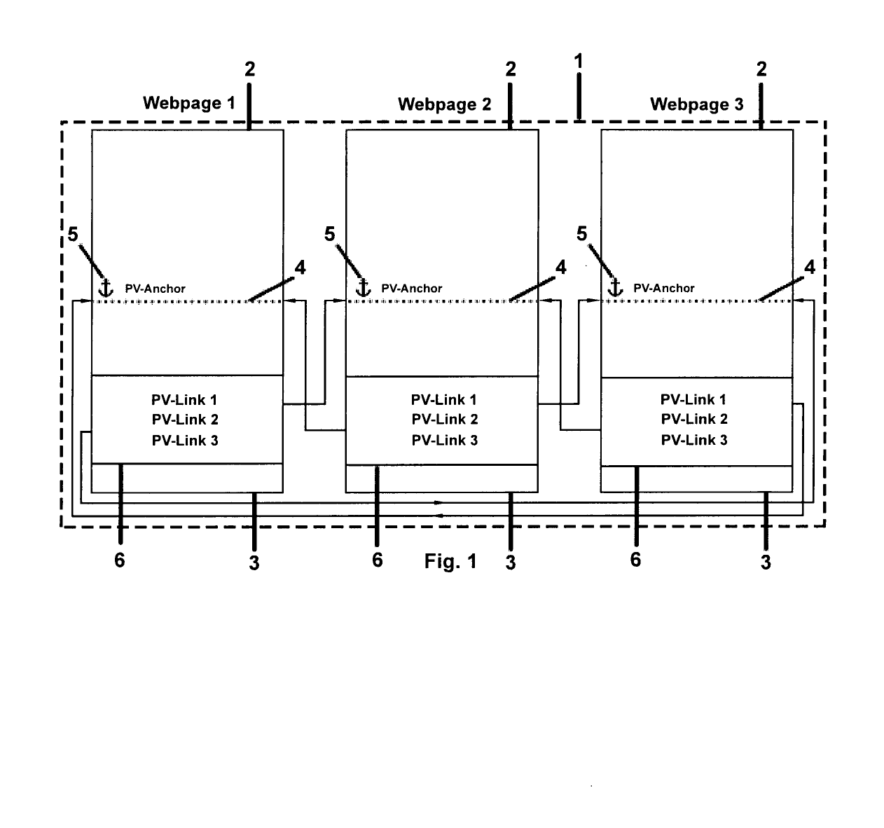

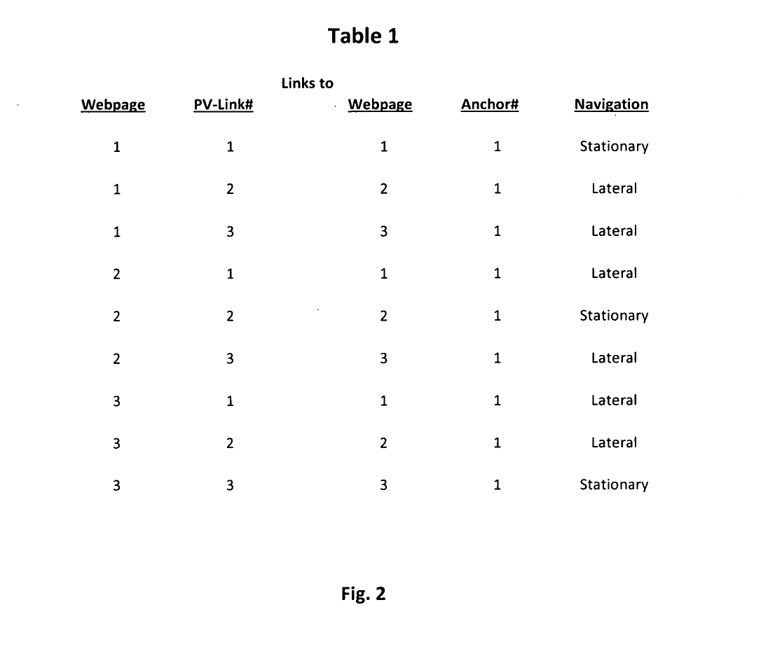

With reference to FIG. 1, an embodiment of a page view navigation system and information network is schematically illustrated. Three distinct webpages are shown. Each distinct webpage has a top 2, a bottom 3, in-webpage view 4, PV-anchor 5, and a PV-navigator-panel 6 containing PV-links. Each PV-link in the PV-navigator panel 6 points to a distinct webpage and recognizes the in-webpage PV-anchor on that page. FIG. 2 shows a PV-link map in table form for the schematic in FIG. 1. When a PV-link is activated, the user navigates to a linked webpage displaying the in-webpage (PV-anchor) view 4 beginning at the PV-anchor 5 of that page. An information network 1 is created by linking the three distinct webpages together using the system of PV-navigators (PV-anchor 5 plus PV-navigator panel 6) on each page.

Table 1 of FIG. 2 provides an alternative way of illustrating a PV-navigation system's navigational capabilities within an information network using the PV-navigator panels 6 on the three webpages depicted in FIG. 1. For example, if a user activates PV-link 1 on webpage 1, the user is not navigated to another webpage or other in-webpage view, but remains at, or is brought back to the in-webpage view 4 of webpage 1 marked by the PV-anchor 5. By contrast, activation of PV-link 1 on webpage 2 laterally navigates the user to the PV-anchor view of webpage 1. When PV-link 2 is activated from webpage 1 the user is navigated laterally to the in-webpage view 4 marked by the PV-anchor 5 on webpage 2. Similarly, if PV-link 3 is activated from webpage 1 or webpage 2, the user is navigated laterally to the in-webpage view 4 marked by the PV-anchor 5 on webpage 3. In this way, lateral navigation between in-webpage views of linked webpages is facilitated by the PV-navigation system comprising the linked network of PV-navigators on each webpage.

### Example 2: Exemplary Page View Navigation System and Information Network

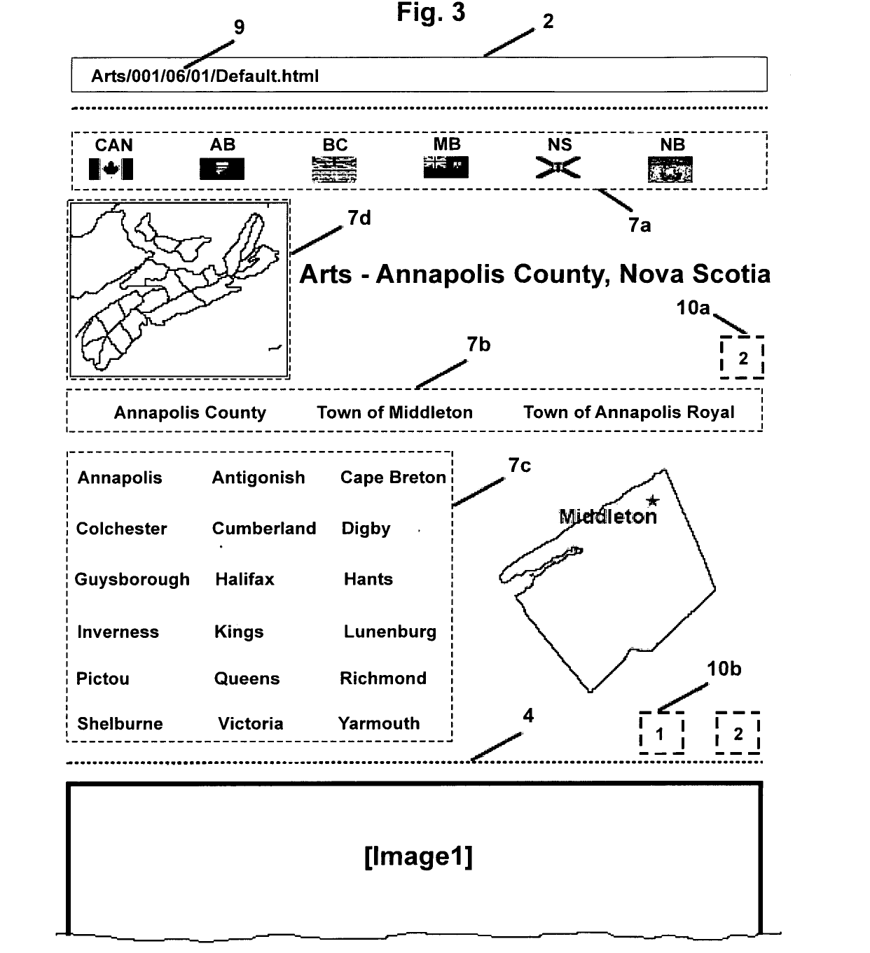

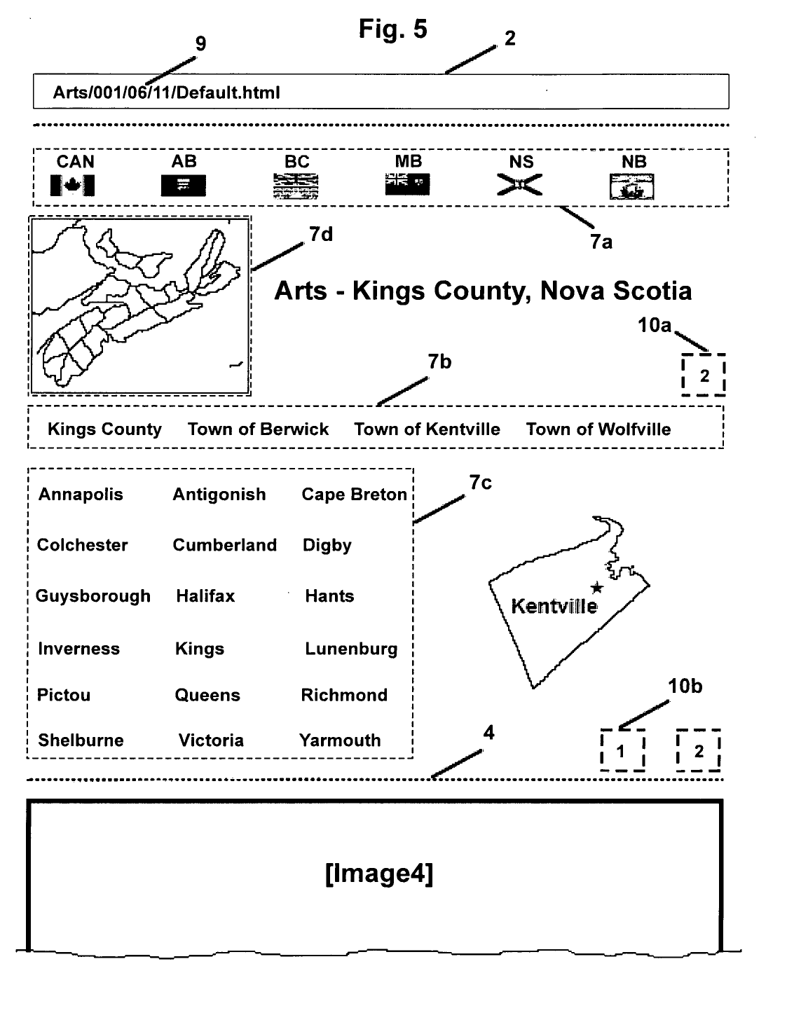

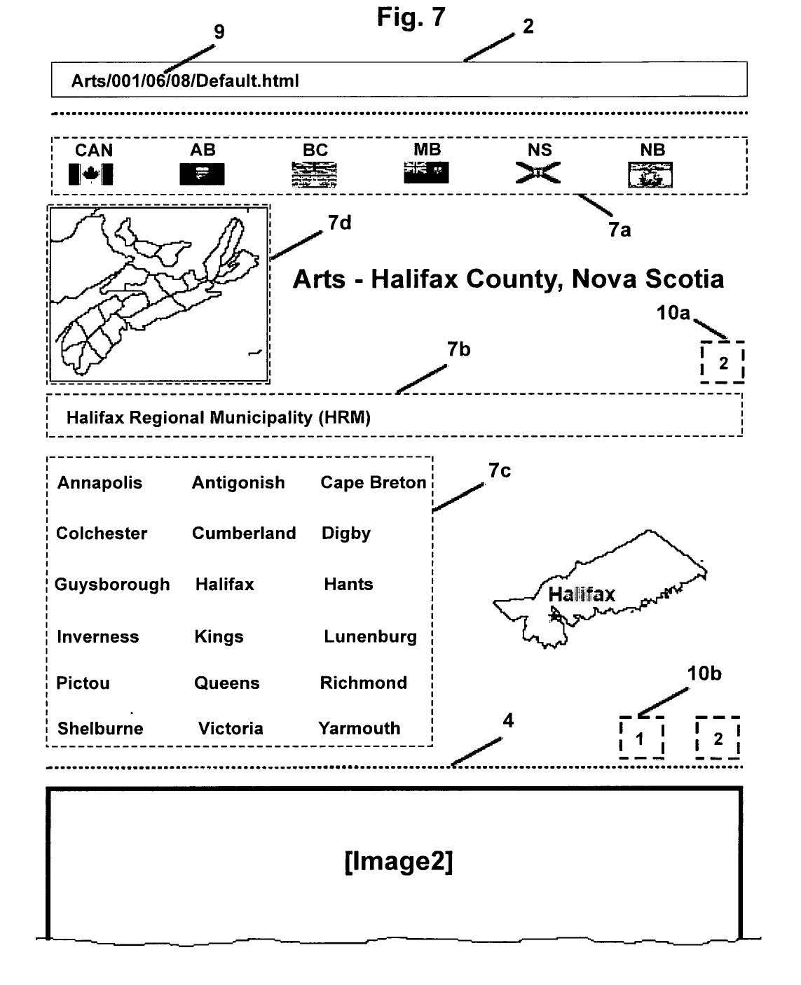

FIGS. 3-8 illustrate top views (FIGS. 3, 5, and 7) and in-webpage (PV-anchor) views (FIGS. 4, 6 and 8) of three webpages linked to form an information network according to the present disclosure. In FIGS. 3, 5 and 7, at the top 2 of each page there is the page URL 9 and various navigation elements such as navigation panels 7a-7d with links to the top 2 of pages with information presented according to a commonly applied standard (see panels 7a, 7c and 7d) and with links to the top 2 of pages with information which is not presented according to a commonly applied standard (see panel 7b). None of the links presented in these panels recognizes a PV-anchor point on the distinct webpage which they navigate the user to once activated. Other links 10a and 10b once activated navigate the user to different views within the same webpage but not to views marked by a PV-anchor on a distinct webpage.

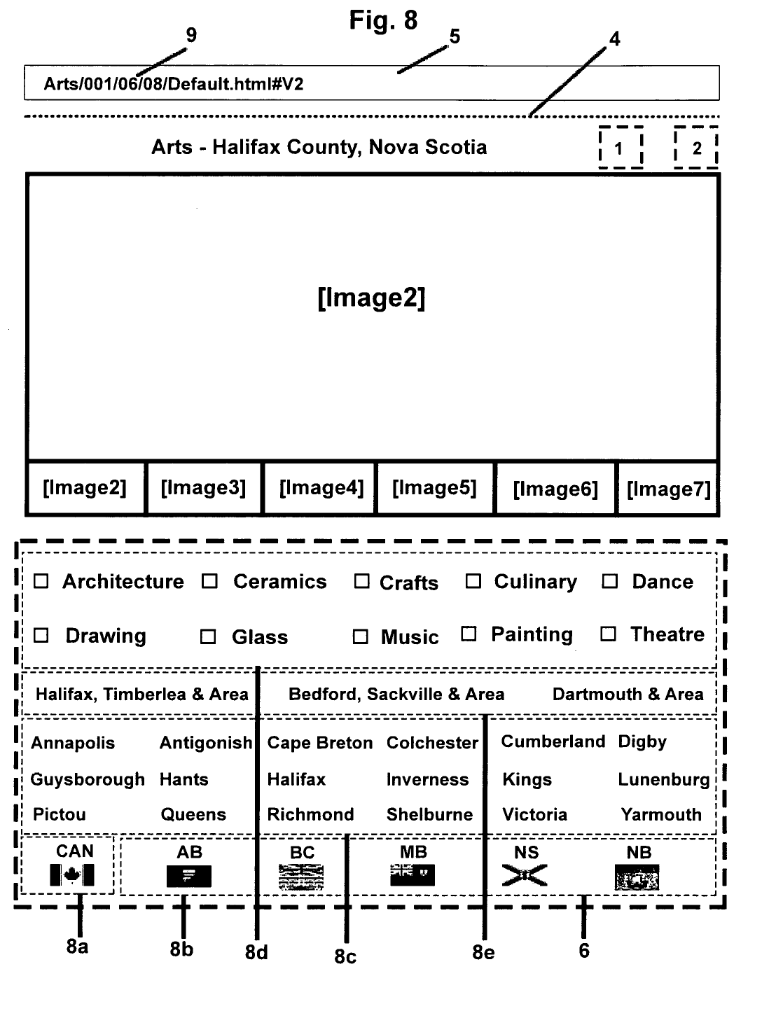

By contrast the in-webpage views of FIGS. 4, 6, and 8 may be navigated to by a user using the PV navigator panel 6 and more particularly using PV-links among the grouping 8c. The combined URL 9 and PV-anchor 5 information illustrated in each of FIGS. 4, 6 and 8, represents the PV-link activated to navigate the user to the respective in-webpage views 4 of the three webpages. Other PV-link groupings 8a, 8b and 8d similarly recognize in-webpage views 4 on other webpages once activated. The groupings of PV-links presented using a common panel presentation style on each linked webpage, illustrates the application of an organizational standard to enhance the efficiency of navigation between pages and create a more seamless navigation experience for the user. The grouping of PV-links 8e in FIG. 8 represent a set of PV-links for a subset of webpages at another level within the information network accessed from the PV-navigator panel on that page, but not accessible from the webpages of FIGS. 3 to 6.

### Example 3: Standardized Page View Navigation System and Information Network Using a Single Database Design

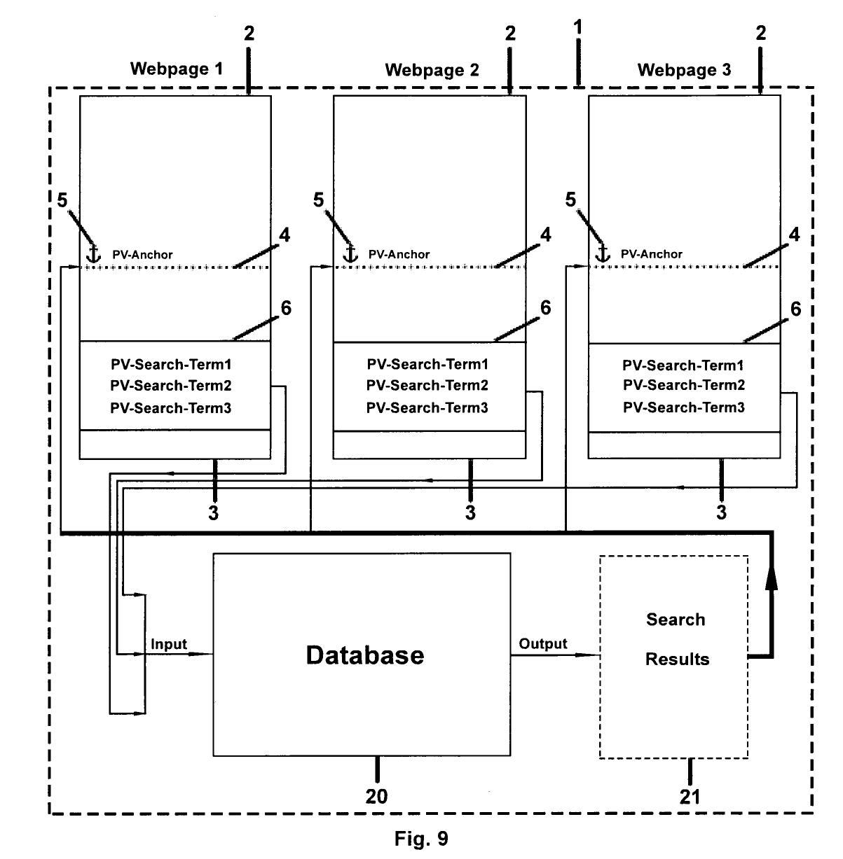

With reference to FIG. 9, an embodiment of a page view navigation system and information network is schematically illustrated. Three distinct webpages are shown. Each distinct webpage has a top 2, a bottom 3, in-webpage view 4, PV-anchor 5, and a PV-navigator panel 6. PV-search-terms in the PV-navigator panel 6 are linked to a PV-searchable-field in a PV-database 20. Each PV-search-term in the PV-navigator panel 6 represents different search criteria that will be submitted to the PV-database 20. Once a PV-search-term is activated a PV-search process is initiated on the PV-search-field. Matching records from a PV-search are displayed in a search results webpage 21. Each matching record in the search results are encoded with the information from the PV-link-field of the PV-database 20. Selecting a matching record from the search results webpage 21 navigates the user to the linked page displaying the in-webpage (PV-anchor) view 4 beginning at the PV-anchor 5 of that page. Selecting more than one matched record opens a new tab in the internet browser for each selection. Single record matches have the option of bypassing the search results webpage and navigating automatically to the linked page. An information network 1 is created by linking the three distinct webpages together using the system of PV-navigators (PV-anchor 5 plus PV-navigator panel 6) on each page. Each webpage that is part of the information network must have a record containing its PV-link information in the PV-database.

### Example 4: Standardized Page View Navigation System and Information Network Using a Multiple Database Design

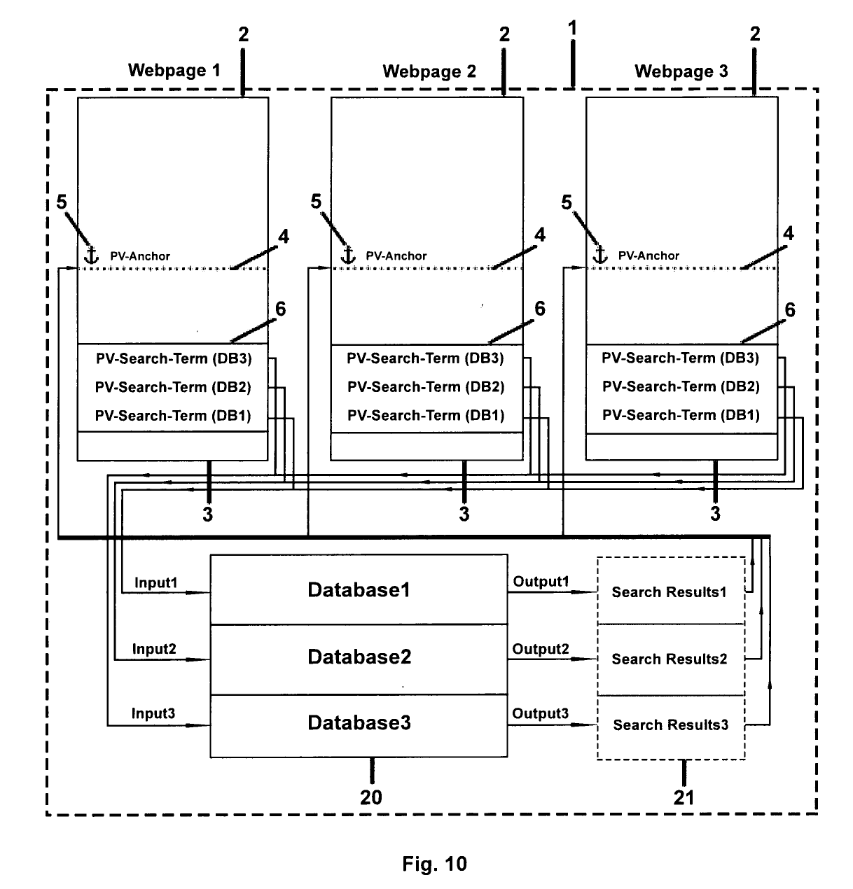

With reference to FIG. 10, an embodiment of a page view navigation system and information network is schematically illustrated. Three distinct webpages are shown. Each distinct webpage has a top 2, a bottom 3, in-webpage view 4, PV-anchor 5, and a PV-navigator panel 6. Each PV-search-term in the PV-navigator panel 6 is linked to a PV-searchable-field in a separate PV-database 20. Each PV-search-term in the PV-navigator panel 6 represents different search criteria that will be submitted to its associated PV-database 20. Once a PV-search-term is activated a PV-search process is initiated on the PV-search-field. Matching records from a PV-search are displayed in a search results webpage 21. Each matching record in the search results are encoded with the information from the PV-link-field of the PV-database 20. Selecting a matching record from the search results webpage 21 navigates the user to the linked page displaying the in-webpage (PV-anchor) view 4 beginning at the PV-anchor 5 of that page. Selecting more than one matched record opens a new tab in the internet browser for each selection. Single record matches have the option of bypassing the search results webpage and navigating automatically to the linked page. An information network 1 is created by linking the three distinct webpages together using a system of PV-navigators (PV-anchor 5 plus PV-navigator panel 6) on each page. Each webpage that is part of the information network must have a record containing its PV-link information in each of the PV-databases.

### Example 5: Standardized Page View Navigation System and Information Network Using a Combination of PV-Links and Multiple Database Design

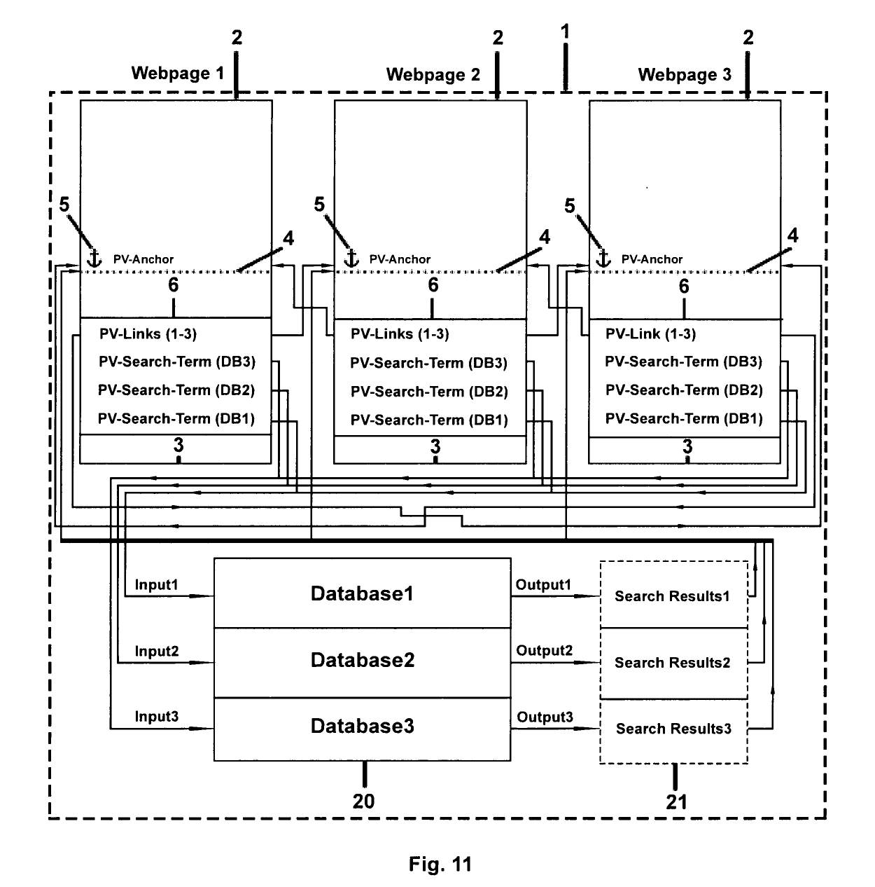

With reference to FIG. 11, an embodiment of a page view navigation system and information network is schematically illustrated. Three distinct webpages are shown. Each distinct webpage has a top 2, a bottom 3, in-webpage view 4, PV-anchor 5, and a PV-navigator panel 6. Each PV-link in the PV-navigator panel 6 points to a distinct webpage and recognizes the in-webpage PV-anchor on that page. When a PV-link is activated, the user navigates to a linked webpage displaying the in-webpage (PV-anchor) view 4 beginning at the PV-anchor 5 of that page. Each PV-search-term in the PV-navigator panel 6 is linked to a PV-searchable-field in a separate PV-database 20. Each PV-search-term in the PV-navigator panel 6 represents different search criteria that will be submitted to its associated PV-database 20. Once a PV-search-term is activated a PV-search process is initiated on the PV-search-field. Matching records from a PV-search are displayed in a search results webpage 21. Each matching record in the search results are encoded with the information from the PV-link-field of the PV-database 20. Selecting a matching record from the search results webpage 21 navigates the user to the linked page displaying the in-webpage (PV-anchor) view 4 beginning at the PV-anchor 5 of that page. Selecting more than one matched record opens a new tab in the internet browser for each selection. Single record matches have the option of bypassing the search results webpage and navigating automatically to the linked page. An information network 1 is created by linking the three distinct webpages together using a system of PV-navigators (PV-anchor 5 plus PV-navigator panel 6) on each page. Each webpage that is part of the information network must have a PV-Link and/or have a record containing its PV-link information in each of the PV-databases.

The disclosures of all patents, patent applications, publications and database entries referenced in this specification are hereby specifically incorporated by reference in their entirety to the same extent as if each such individual patent, patent application, publication and database entry were specifically and individually indicated to be incorporated by reference.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

The embodiments of the invention in which an exclusive property or privilege is claimed are defined as follows:

1. A page view navigator for navigating in-webpage views on a plurality of webpages, comprising a page view anchor marking an in-webpage view on a webpage and one or more page view links accessible from said webpage, each link being operatively associated with a distinct webpage and configured to recognize a distinct page view anchor on said distinct webpage.

2. The page view navigator of claim 1, further comprising one or more page view search terms on the same webpage as the page view anchor and a page view database operatively associated with said page view search terms, wherein activating the one more page view search terms initiates a page view search in the page view database to access the one or more page view links.

3. The page view navigator of claim 1, wherein the one or more page view links are presented to the user in a page view navigator panel.

4. The page view navigator of claim 3, wherein said page view navigator panel is part of the in-webpage view marked by the page view anchor.

5. The page view navigator of claim 1, wherein the in-webpage views on the plurality of webpages comprise content configured according to a user-defined standard.

6. The page view navigator of claim 5, wherein the user-defined standard is a set of content management rules for organizing, processing, and displaying information.

7. A page view navigation system for an internet information network comprising one or more page view navigators for navigating between two or more webpages, wherein each page view navigator comprises a page view anchor and one or more page view links, each of which is operatively associated with a distinct webpage and configured to recognize a distinct page view anchor on said distinct webpage.

8. The page view navigation system of claim 7, wherein the one or more page view navigators are for navigating between two or more in-webpage views on said two or more webpages.

9. A method for constructing an internet information network comprising the step of linking in-webpage views of a plurality of webpages using one or more page view navigators, wherein each page view navigator comprises a page view anchor marking an in-webpage view on a webpage and one or more page view links accessible from said webpage, each link being operatively associated with a distinct webpage and configured to recognize a distinct page view anchor on said distinct webpage.
